(19) United States
(12) Patent Application Publication
(10) Pub. No.: US 2018/0350493 A1
(43) Pub. Date: Dec. 6, 2018

(54) DISTRIBUTED GAP FOR MAGNETIC CORES

(71) Applicant: Solaredge Technologies Ltd., Herzeliya (IL)

(72) Inventors: Shimon Khananashvili, Jerusalem (IL); Yiftah Kowal, Ramat Gan (IL)

(21) Appl. No.: 15/995,389

(22) Filed: Jun. 1, 2018

Related U.S. Application Data
(60) Provisional application No. 62/513,602, filed on Jun. 1, 2017.

(51) Int. Cl. H01F 3/14; H01F 27/24; H01F 27/28

(52) U.S. Cl. CPC H01F 3/14; H01F 2027/2819; H01F 27/28; H01F 27/24

(57) ABSTRACT

Magnetic cores are described for inductors, transformers and any other electrical wound components. The magnetic cores may have one or more gaps, which may be distributed and/or oblique, and which may be broken up into multiple non-contiguous gaps.

### CROSS-REFERENCE TO RELATED APPLICATIONS

The present application claims priority to U.S. Provisional Patent Application Ser. No. 62/513,602, entitled “Distributed Gap for Magnetic Cores,” filed Jun. 1, 2017, hereby incorporated by reference as to its entirety.

### BACKGROUND

Electrical wound components, such as inductors and transformers, may comprise a magnetic core, such as an iron core and/or a ferrite core, which may increase the magnetic flux produced by a given current flow in the windings. A magnetic core may have air gaps, or gaps filled with different non-magnetic materials to alter the properties of the core. Gaps in a magnetic core may cause flux fringing near the edges of the gap, which may lead to heating and/or energy loss at windings close to the gap. A gap may allow more energy to be stored in a magnetic core and lower saturation effects. There is a need for a magnetic core comprising a gap with lower losses due to the fringing flux effect.

### SUMMARY

The following is a short summary of some of the inventive concepts for illustrative purposes only, is not intended to limit or constrain the inventions and examples in the detailed description, and is not intended to identify key or essential features. One skilled in the art will recognize other novel combinations and features from the detailed description.

Illustrative embodiments disclosed herein may present apparatuses and methods for designing an electrical element with inductive properties having small energy losses.

Embodiments herein may include magnetic cores having one or more distributed gaps for inductors, transformers and any other electrical wound components.

By way of example, some aspects as described herein are directed to an apparatus that comprises a first magnetic core element and a second magnetic core element. The first magnetic core element may comprising a first yoke and a first center leg coupled to the first yoke. The second magnetic core element may comprise a second yoke and a second center leg coupled to the second yoke. The first magnetic core element and the second magnetic core element may be configured to be stacked against each other and form a magnetic core comprising a first gap (e.g., a distributed gap that may be an oblique gap) between the first center leg and the second center leg. The first center leg, the first gap and the second center leg may be configured to be wound with a conductor.

The first magnetic core element may be manufactured as a first single cast, and the second magnetic core element may be manufactured as a second single cast. Additionally or alternatively, the first magnetic core element and the second magnetic core element may be manufactured using identical molds.

The first magnetic core element may further comprise a first group of one or more outer legs. Similarly, the second magnetic core element may further comprise a second group of one or more outer legs. The first group of the one or more legs may be in contact with at least one of the legs of the second group of the one or more outer legs.

In addition, a third magnetic core element may be placed between the first center leg and the second center leg. This may result in the third magnetic core element and the first center leg forming a second gap, and/or the third magnetic core element and the second center leg forming a third gap. The second and/or third gaps may each be a distributed gap that may be an oblique gap.

Any of the gaps (e.g., the first, second, and/or third gaps) may be empty (e.g., an air gap) or may be partially or fully filled with a non-magnetic material.

Certain variations of embodiments as described herein may provide an improved apparatus for an electrical element with inductive properties.

As noted above, this Summary is merely a summary of some of the features described herein and is provided to introduce a selection of concepts in a simplified form that are further described below in the Detailed Description. The Summary is not exhaustive, is not intended to identify key or essential features.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 shows an apparatus with inductive properties according to illustrative embodiments.

FIG. 2 shows an apparatus with inductive properties according to illustrative embodiments.

FIG. 3 illustrates conductors according to illustrative embodiments.

FIG. 4 illustrates four diagrams of different types of magnetic cores.

FIG. 5 illustrates a plurality of distributed gaps according to illustrative embodiments.

FIG. 6 illustrates a split distributed gap according to illustrative embodiments.

FIG. 7 illustrates magnetic core elements having interconnecting agents according to illustrative embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized and structural and functional modifications may be made, without departing from the scope of the present disclosure.

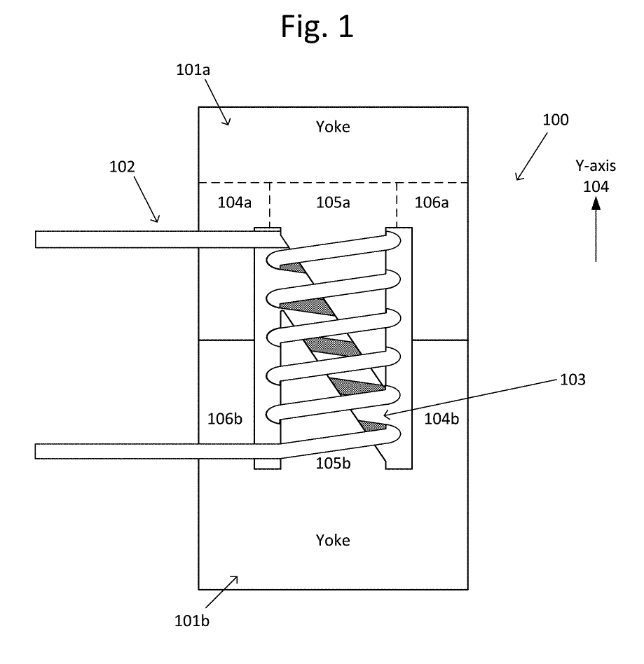

Reference is now made to FIG. 1, which illustrates a cross-section view of an apparatus with inductive properties according to illustrative embodiments. An electrical device 100 comprises complementary magnetic core elements 101a and 101b, conductor 102, and distributed gap 103. Magnetic core elements 101a and 101b may be of any shape, such as E-shaped cores, pot cores, EP cores, etc, and together form a magnetic core. The two-dimensional cross section of magnetic core elements 101a and 101b may each comprise a yoke, and a plurality of legs, such as a first leg (legs 104a and 104b, respectively), a second leg (legs 105a and 105b, respectively), and a third leg (legs 106a and 106b, respectively (e.g., to form an E core). In some embodiments, the magnetic core elements 101a and 101b may each comprise two legs (e.g. an EP core).

Magnetic core elements 101a and 101b may be manufactured using any of several methods, such as casting, three-dimensional printing, being formed by hand, wire electrical discharge machining, sintering powder, stamping, and/or other machining operations (e.g. turning, milling, shaving, and/or drilling operations). In some embodiments, at least one magnetic core element of magnetic core elements 101a and 101b may be formed as a single cast. In some embodiments, at least one magnetic core element of magnetic core elements 101a and 101b may be assembled with smaller magnetic parts, such as various prism-like magnetic parts.

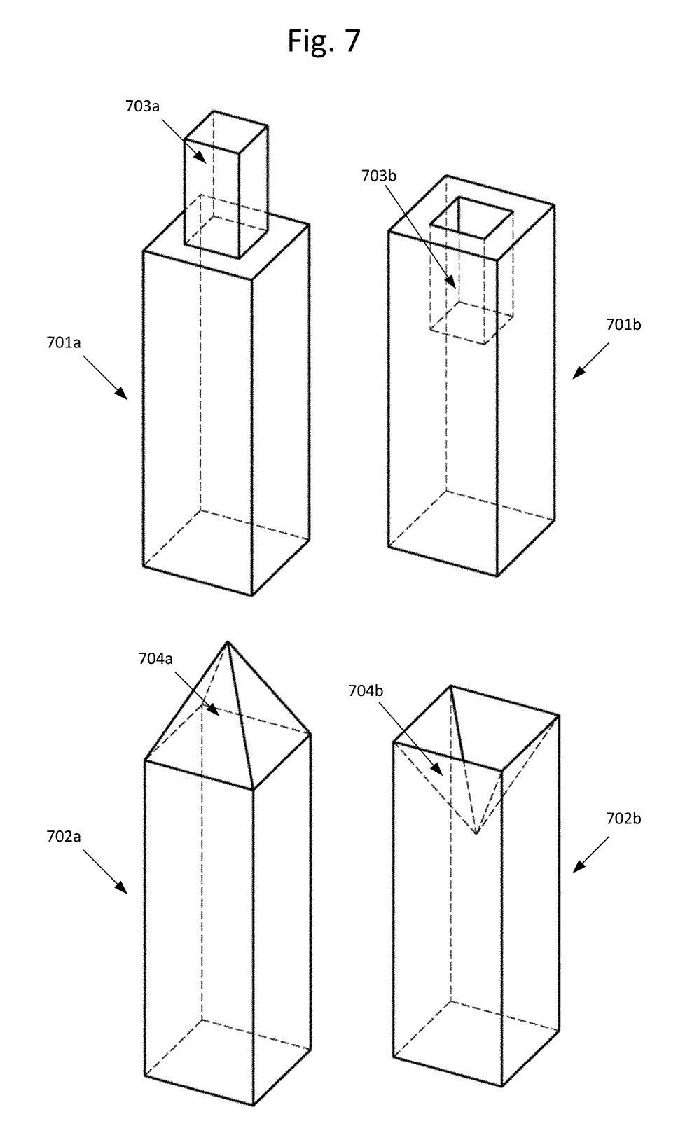

Magnetic core elements 101a and 101b may be arranged to fit together such that certain legs of one magnetic core element are in contact with certain legs of the other magnetic core element. For instance, the first and third legs 104a and 106a of magnetic core element 101a may be in contact with the first and third legs 104b and 106b of magnetic core element 101b, such as shown in FIG. 1. In some embodiments, legs that are in contact or otherwise fit together may have interconnecting agents that fit together as a pair, such as matched cavities and protrusions. For example, the first leg 104a of magnetic core element 101a may comprise a cavity and the third leg 106b of magnetic core element 101b may comprise a protrusion, as shown in greater detail in FIG. 7. The protrusion may be designed to fit in the cavity so that 104a and leg 106b fit together. The same may be true for the pair of legs 106a and 104b. The protrusions and the cavities may be used to align magnetic core elements 101a and 101b, for example, by arranging the magnetic core elements 101a and 101b such that the protrusion of the first leg 104a of magnetic core element 101a is inserted in the cavity of the third leg 106b of magnetic core element 101b, and such that the protrusion of the first leg 104b of magnetic core element 101b is inserted in the cavity of the third leg 106a of magnetic core element 101a. The protrusions and cavities may be opposite the above example, such as protrusions in legs 106a and 106b and cavities in legs 104a and 104b, or in any other combination of protrusions and cavities. In either case, magnetic core elements 101a and 101b may be arranged together such that one or more other legs (e.g., the second legs 105a and 105b) of magnetic core elements 101a and 101b might not be in contact with each other, leaving a space between them. The space between the second legs 105a and 105b may be referred to as a distributed gap 103. Distributed gap 103 may also be at least partially between any other pairs of the legs, such as between legs 104a and 106b and between legs 106a and 104b, as shown in FIG. 1. Distributed gap 103 may be an oblique gap if the area facing distributed gap 103 of each second leg 105a and 105b of magnetic core elements 101a and 101b comprises at least one oblique and/or slanted section. Conductor 102 may be wound around the second leg 105a of magnetic core element 101a, around distributed gap 103, and around the second leg 105b of magnetic core element 101b. The second legs 105a and 105b of magnetic core elements 101a and/or 101b may be designed to be at least partially covered with a bobbin.

In some embodiments, magnetic core element 101a and magnetic core element 101b may be substantially the same shape and size, which may provide an advantage of allowing simple and effective manufacturing (e.g., casting the magnetic core elements 101a and 101b using a single mold).

In some embodiments, magnetic core elements 101a and 101b each may be designed to provide a second leg cross-section perpendicular to the direction of magnetic flux traversing the second leg, that may be about equal in area to the sum of the areas of cross-sections of the first and third legs perpendicular to the direction of the magnetic flux traversing the first and third legs. For example, referring to magnetic core element 101a, leg 105a may have a cross-sectional area that is perpendicular to the direction of the magnetic flux traversing leg 105a. Legs 104a and 106a may each have a cross-sectional area that is perpendicular to the direction of the magnetic flux traversing legs 104a and 106a, respectively. The cross-sectional area of leg 105a may be about equal to the sum of the cross-sectional areas of legs 104a and 106a. The same may be true for the other magnetic core element 101b, replacing legs 104a, 105a, and 106a in the above discussion with legs 104b, 105b and 106b, respectively.

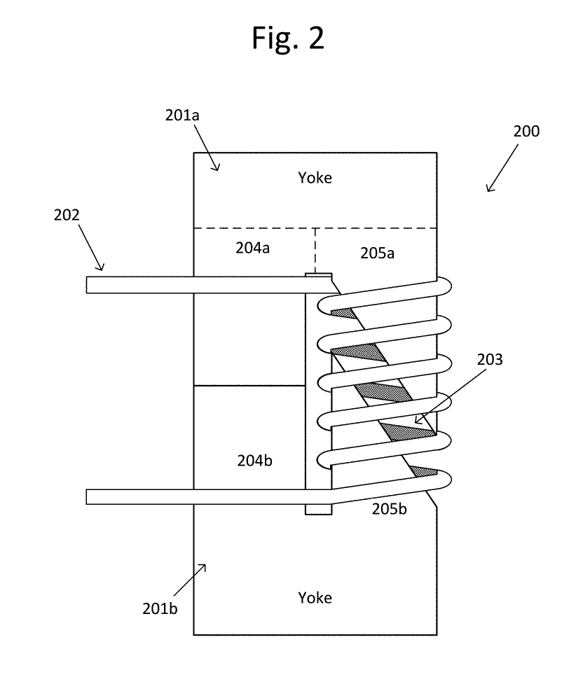

Reference is now made to FIG. 2, which illustrates a cross-section view of an apparatus (in this case, an electrical device 200) with inductive properties according to illustrative embodiments. Complementary magnetic core elements 201a and 201b may be U-shaped or C-shaped cores, each comprising a first leg (204a and 204b, respectively) and a second leg (205a and 205b, respectively), wherein the second leg of each magnetic core element may be similar to the second leg of magnetic core elements 101a and 101b. Magnetic core elements 201a and 201b may be arranged such that a first pair of first legs 204a and 204b of magnetic core elements 201a and 201b may be in or near contact with each other, and a second pair of second legs 205a and 205b may form a distributed gap 203 between them. The first pair of first legs 204a and 204b may feature a cavity in one of the first legs and a protrusion in the other first leg, as shown in greater detail in FIG. 7. The protrusion may be designed to fit in the cavity, in the same way discussed previously with regard to FIGS. 1 and 7. The protrusion and the cavity may improve the alignment of magnetic core elements 201a and 201b, by inserting the protrusion of one first leg into the cavity of the other first leg. Distributed gap 203 may be an oblique gap. Conductor 202 may be wound around the second leg 205a of magnetic core element 201a, around distributed gap 203, and around the second leg 205b of magnetic core element 201b.

At the edges of an air gap in a magnetic core, such as distributed gaps 103 of FIG. 1 and 203 of FIG. 2, there may be a relatively large magnitude of fringing magnetic flux. As a result, significant eddy currents may be generated in conductors wound around the magnetic core and air gap. Stretching an air gap (similarly to as shown with regard to distributed gaps 103 and/or 203) over more windings of a conductor wound around the magnetic core and air gap (such as conductor 102 of FIG. 1 and conductor 202 of FIG. 2) may reduce the fringing flux affecting a single winding, and spread the fringing flux to more windings, which may reduce the risk of a “hot spot” developing and may improve performance (e.g. lower temperature, lower losses) of electrical device 100.

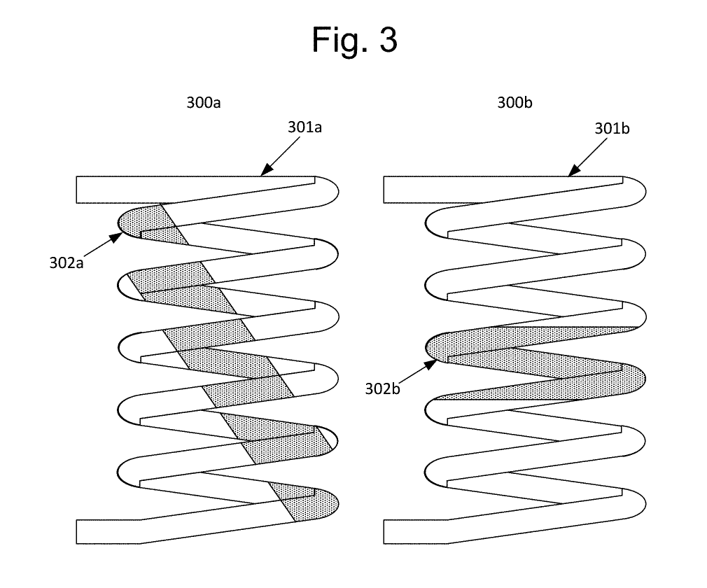

Reference is now made to FIG. 3, which illustrates conductors according to illustrative embodiments. Conductors 300a and 300b may each be similar to conductor 102 of FIG. 1. Conductor 300a may be wound around one or more legs of a first magnetic core (not explicitly shown, for clarity), such as the magnetic core of electrical device 100 or electrical device 200, that comprises a first gap (e.g., similar to distributed gap 103 of FIG. 1). Conductor 300b may be wound around one or more legs of a second magnetic core that comprises a second gap. The first gap may be “stretched” over more windings than the second gap (i.e., the first gap may have a more prominently oblique shape than the second gap). Conductor 300a may comprise area 301a (shown unshaded) and area 302a (shown shaded). Conductor 300b may comprise area 301b and area 302b. Areas 301a, 302a, 301b, and 302b may each be continuous or non-continuous areas, and may each be of the shapes and sizes shown in FIG. 3 or of different shapes and sizes as desired. In this example, shaded area 302a indicates the portion of conductor 300a that is disposed across (e.g., wound around) the first gap, and area 301a indicates the portion of conductor 300a that is disposed across (e.g., wound around) the first magnetic core and may be substantially in contact with the first magnetic core. Similarly, in this example, shaded area 302b indicates the portion of conductor 300b that is disposed across (e.g., wound around) the second gap, and area 301b indicates the portion of conductor 300b that is disposed across (e.g., wound around) the second magnetic core and may be substantially in contact with the second magnetic core. Because area 302a is disposed across the first gap, area 302a may be affected by a fringing flux more than area 301a. Similarly, area 302b is disposed across the second gap and thus may be affected by a fringing flux more than area 301b. Because the first gap in this example has an increased oblique shape compared to the second gap, the windings of conductor 300a may be affected by a fringing flux more evenly than the windings of conductor 300b. As a possible result, if conductor 300a and the first magnetic core are arranged to form a first inductor, and conductor 300b and the second magnetic core are arranged to form a second inductor having an inductance approximately equal to the inductance of the first inductor, the first inductor may provide reduced energy losses and/or may feature a more uniform heating of the corresponding conductor (e.g., 300a) and/or may have reduced induction heating, when compared to the second inductor.

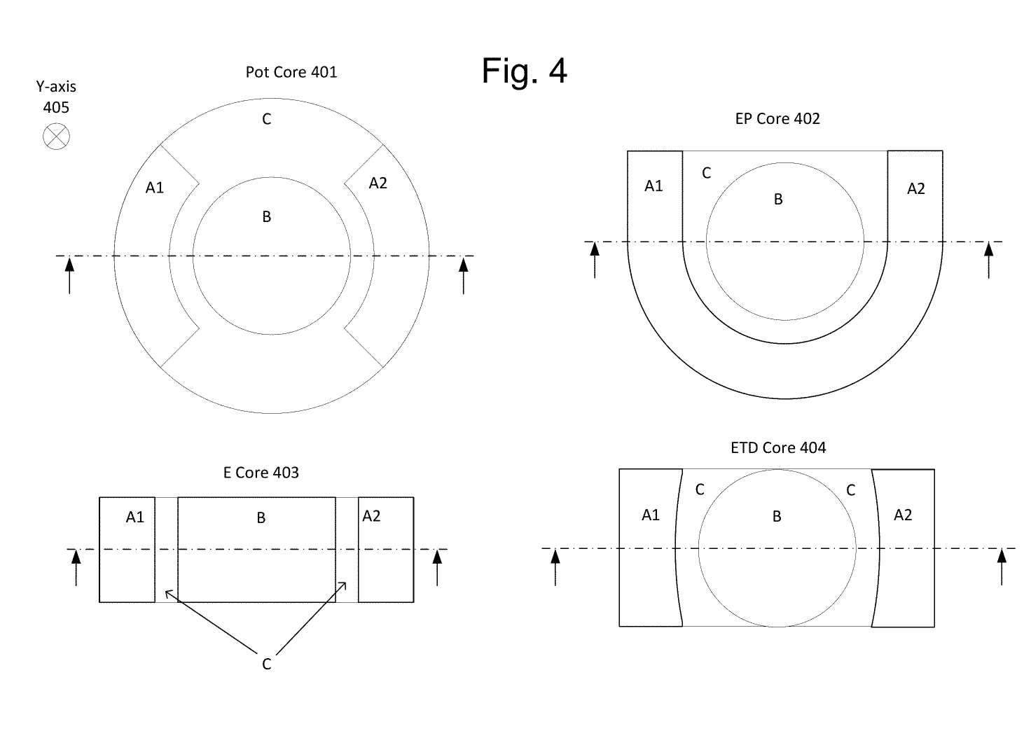

Reference is now made to FIG. 4, which illustrates four diagrams of different example types of magnetic core elements. The four diagrams show magnetic core elements according to illustrative embodiments, which can be paired together to form magnetic cores. Y-axis 405, which points out of the page, may correspond to Y-axis 104 of FIG. 1, which points towards the top of that page. Any of the magnetic core elements shown in FIG. 4 may be used in the magnetic core in, e.g., electrical device 100. Thus, each of the magnetic core elements shown in FIG. 4 may be implemented as, e.g., magnetic core element 101a or 101b. The views in FIG. 4 may also be seen as an assembled magnetic core containing two complementary magnetic core elements, such as magnetic core elements 101a and 101b, fitted together. Areas marked with an “A1”, “A2”, or a “B” in each view represent areas having a different height in the Y-axis direction than areas marked with a “C”, and may be legs of the magnetic core elements. Furthermore, areas marked with an “A1”, “A2”, or a “B” may be designed to form a distributed gap when placed against (e.g., fitted with) its complementary magnetic core, where the gap may be formed in the region of area “C”. The dashed lines represent cross-sections that will result in a 3-legged, 2-dimensional shape similar to magnetic core elements 101a and 101b of FIG. 1. For example, the regions in each example magnetic core element designated as A1 in FIG. 4 may correspond to leg 104a and/or leg 106b of electrical device 100 in FIG. 1, the region designated as A3 in FIG. 4 may correspond to leg 106a and/or leg 104b, the region designated as B in FIG. 4 may correspond to leg 105a and/or 105b, and the region designated as C in FIG. 4 may form the vertical portions of the distributed gap 103. In this example, the distributed gap 103 may also extend through region B (as the angled/oblique portion of the distributed gap 103) and even extend partially into regions A1 and A2.

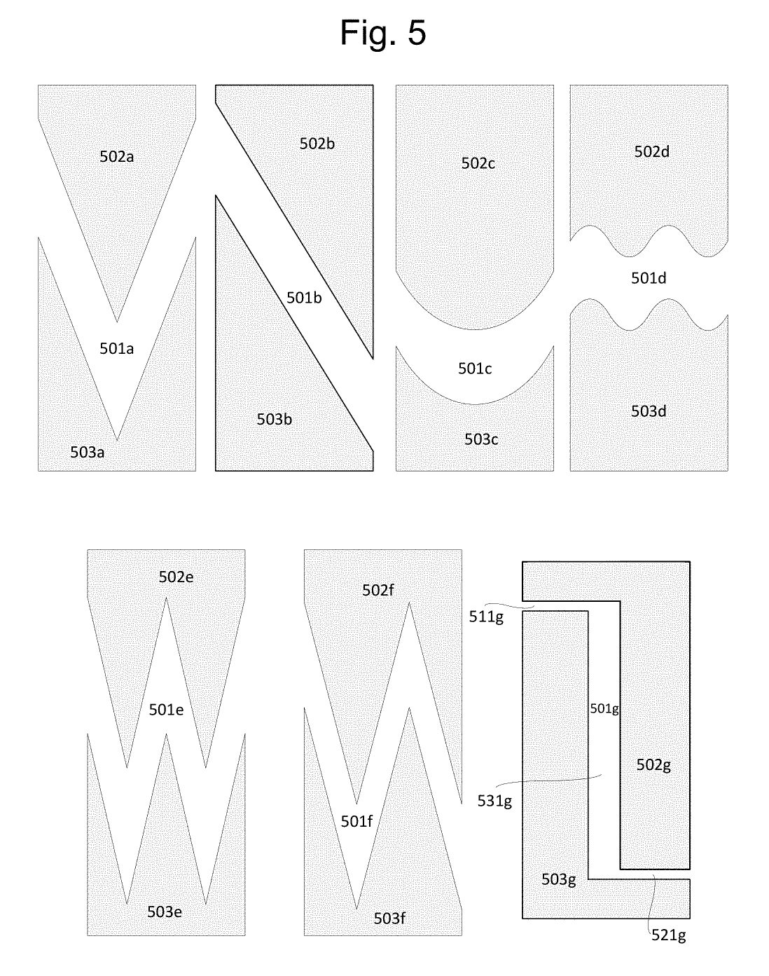

Reference is now made to FIG. 5, which illustrates further examples of distributed gaps according to illustrative embodiments. While various configurations of distributed gaps, along with the magnetic core legs that define those distributed gaps, these are only examples. Any configuration of distributed gaps and legs may be used. Further examples of such configurations are presented in FIG. 5, which shows distributed gaps 501a-g defined by spaces between complementary legs 502a-g and 503a-g. The distributed gaps in any of the embodiments described in connection with FIGS. 1-4 may be replaced with any of distributed gaps 501a-501g, or with any other distributed gap configurations, as desired. Moreover, each of the legs 502a-g and 503a-g may be used to implement any of the legs in any of the embodiments of FIGS. 1-4. For example, any of legs 502a-g may be used to implement leg 105a or leg 205a, and any of legs 503a-g may be used to implement leg 105b or leg 205b. Each of distributed gaps 501a-501g may extend across one or more legs of a magnetic core, such as in the same manner shown and described in connection with FIGS. 1 and 2. If a distributed gap does extend in this manner, more windings of a conductor wound around a leg of a magnetic core may be affected by the proximity to the distributed gap (as explained above in connection with FIG. 3), and the windings may be affected by the fringing flux effect more evenly with respect to a less “stretched” distributed gap. With respect to distributed gap 501g, which may be considered a vertical gap, it may be formed by a gap portion 531g (which may be substantially vertical) and two gap portions 521g and 511g substantially perpendicular to gap portion 531g (and which may be substantially horizontal relative to gap portion 531g). Conductive windings (e.g., similar to windings 202 of FIG. 2) may be wound around portion 531g, and heat generated in the windings may be distributed along the windings along the length of gap portion 531g. According to some aspects, one or both of gap portions 521g and 511g might not be featured. Where gap portions 521g and 511fg are not featured, magnetic core elements 502g and 503g may be physically interconnecting with each other. For example, a first end of magnetic core element 502g may feature a protrusion, and a second end of magnetic core element 503g may feature a corresponding cavity (e.g., as illustrated in FIG. 7 and described below), and a first end of magnetic core element 503g may feature a protrusion, and a second end of magnetic core element 502g may feature a corresponding cavity. In this manner, magnetic core elements 502g and 503g may be substantially identical to each other, and may be manufactured using a single mold, while still being interconnecting and designed to form distributed gap 501g.

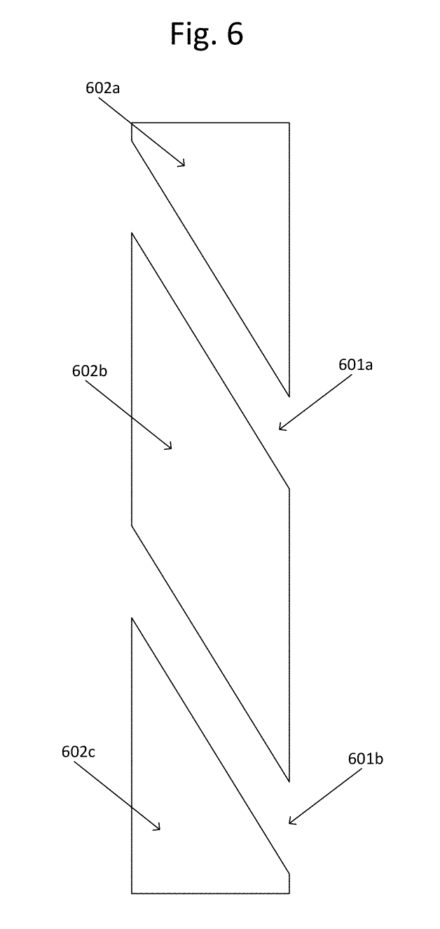

Reference is now made to FIG. 6, which illustrates a split distributed gap according to illustrative embodiments. In this example, the distributed gap is split into two non-contiguous parts 601a and 601b. In further examples, the distributed gap may be split into more than two non-contiguous parts, such as three or more parts. A split distributed gap, such as shown by way of example in FIG. 6 or in any other split configuration, may be implemented in any of the embodiments shown and described in connection with FIGS. 1-5. In the particular example shown in FIG. 6, the magnetic core may comprise magnetic core parts 602a, 602b, and 602c, which may or may not be implemented in a leg of the magnetic core, such as legs 105a, 105b, 205a, and/or 205b. In this example, magnetic core parts 602a and 602b form distributed gap 601a between them, and magnetic core parts 602b and 602c form distributed gap 601b between them. Splitting a distributed gap into a plurality of distributed gaps (e.g., at least two gaps, at least three gaps, or even more) may reduce the fringing flux effect and may allow a larger amount of energy to be stored in the distributed gaps.

Reference is now made to FIG. 7, which illustrates magnetic core elements 701a, 701b, 702a, and 702b having interconnecting agents 703a, 703b, 704a, and 704b according to illustrative embodiments. The magnetic core elements 701a, 701b, 702a, and 702b may be implemented as legs or other elements in any of the embodiments shown and described in connection with FIGS. 1-6. For example, any of legs 104a, 106a, or 204a may be implemented as legs 701a or 702a, and any of legs 104b, 106b, or 204b may be implemented as legs 701b or 702b. Thus, for example, leg 701a may be a part of a first magnetic core element (e.g., element 101a or 201a), and leg 701b may be a part of a second magnetic core element (e.g., element 101b or 201b) complementary to the first magnetic core element. Leg 701a may comprise protrusion 703a and leg 702b may comprise cavity 703b. When stacking together the first magnetic core and the second magnetic core, leg 701a and leg 701b may be configured to have protrusion 703a fit inside cavity 703b.

In a similar manner, leg 702a may be a part of a first magnetic core element (e.g., element 101a or 201a) and leg 701b may be a part of a second magnetic core element (e.g., element 101b or 201b) complementary to the first magnetic core element. Leg 702a may comprise protrusion 704a and leg 702b may comprise cavity 704b. When stacking together the first magnetic core and the second magnetic core, leg 702a and leg 702b may be configured to have protrusion 704a fit inside cavity 704b.

Fitting a protrusion (such as protrusion 703a and/or 704a) inside a cavity (such as cavity 703b and/or 704b, respectively) may help align, to a preferred aligned position, a first leg of a one magnetic core element having the protrusion and a second leg of another complementary magnetic core element having the cavity, and may help decrease the magnetic core elements' deviation from the preferred aligned position. The preferred aligned position may be a position wherein the center legs (such as the second leg of FIG. 1) are to a considerable extent directly above each other.

In some embodiments, the distributed gap may be located between the outer (e.g. first or third legs of FIG. 1) legs of magnetic core elements.

In some embodiments, the protrusion (such as protrusion 703a and/or 704a) and cavity (such as cavity 703b and/or 704b) may be designed to be a part of the center legs of magnetic core elements, and in further embodiments the protrusion and cavity may be part of other legs of magnetic core elements. Also, while the interconnecting agents in FIG. 7 are shown and described as protrusions and cavities, the interconnecting agents may be any other types of interconnecting agents that are designed to fit together. For example, the interconnecting agents may be snap connectors, welds, solders, glues, knobs, buttons, threaded (e.g., screw-type) connectors, etc. In some embodiments, the interconnecting agents may be implemented as complementary male/female pairs (such as the protrusion and cavity pair examples shown in FIG. 7).

Illustrative aspects disclosed herein make use of an air gap as an example of a gap featured in a magnetic core, the gap having different ferromagnetic properties from other core elements. According to some aspects, the gap (e.g., the distributed gap in any of the embodiments shown and described in connection with FIGS. 1-7) of a magnetic core may feature a gap partially or fully filled using a material (e.g., FR-4) which is different from the material of the magnetic core elements.

1. An apparatus comprising:
a first magnetic core element comprising:
a first yoke; and
a first center leg coupled to the first yoke, and
a second magnetic core element comprising:
a second yoke; and
a second center leg coupled to the second yoke, wherein the first magnetic core element and the second magnetic core element are configured to be stacked against each other and form a magnetic core comprising a first oblique gap between the first center leg and the second center leg.

2. The apparatus of claim 1, wherein the first magnetic core element is manufactured as a first single cast, and wherein the second magnetic core element is manufactured as a second single cast.

3. The apparatus of claim 1, wherein the first magnetic core element further comprises a first group of one or more outer legs, and the second magnetic core element further comprises a second group of one or more outer legs.

4. The apparatus of claim 3, wherein the first group of the one or more outer legs is in contact with at least one leg of the second group of the one or more outer legs.

5. The apparatus of claim 1, wherein the first magnetic core element and the second magnetic core element are manufactured using identical molds.

6. The apparatus of claim 1, wherein the first oblique gap between the first center leg and the second center leg is filled with a non-magnetic material.

7. The apparatus of claim 1, wherein a third magnetic core element is placed between the first center leg and the second center leg, wherein the third magnetic core element and the first center leg form a second oblique gap, and wherein the third magnetic core element and the second center leg form a third oblique gap.

8. The apparatus of claim 1, wherein the first magnetic core element and the second magnetic core element comprise a plurality of protrusions forming a plurality of oblique gaps.

9. The apparatus of claim 1, further comprising conductive windings wound around the first magnetic core element and the second magnetic core element.

10. The apparatus of claim 1, wherein the first center leg and the second center leg comprise interconnecting elements.

11. An apparatus comprising:
a first magnetic core element comprising:
a first yoke; and
a first center leg coupled to the first yoke, and
a second magnetic core element comprising:
a second yoke; and
a second center leg coupled to the second yoke, wherein the first magnetic core element and the second magnetic core element are configured to be stacked against each other and form a magnetic core comprising a first vertical gap between the first center leg and the second center leg.

12. The apparatus of claim 11, wherein the first magnetic core element is manufactured as a first single cast, and wherein the second magnetic core element is manufactured as a second single cast.

13. The apparatus of claim 12, wherein the first magnetic core element and the second magnetic core element are manufactured using identical molds.

14. The apparatus of claim 11, further comprising conductive windings wound around the first magnetic core element and the second magnetic core element.

15. The apparatus of claim 11, wherein the first center leg and the second center leg comprise interconnecting elements.
